(19) United States
(12) Patent Application Publication
(10) Pub. No.: US 2015/0075687 A1
(43) Pub. Date: Mar. 19, 2015

(54) Tire Cradle and Method

(71) Applicant: Keith McCloud, Snohomish, WA (US)

(72) Inventor: Keith McCloud, Snohomish, WA (US)

(21) Appl. No.: 14/272,057

(22) Filed: May 7, 2014

Related U.S. Application Data
(60) Provisional application No. 61/820,323, filed on May 7, 2013.

(51) Int. Cl. B60C 27/00

(52) U.S. Cl. CPC B60C 27/003
USPC 152/213 R

(57) ABSTRACT

An apparatus for easily and safely installing or removing tire chains from the outside tire on a dual tire, single axle, motor vehicle. The apparatus includes a four sided pyramid-shaped base with a flat bottom surface, two upward converging surfaces, an elevated concave tire support surface disposed between the two converging surfaces, a tire centering sensor mounted in the tire support surface, and a signaling device coupled to the tire centering sensor. The sensor and signaling device are configured to inform the driver when a tire has properly aligned in the tire support surface. Using the apparatus a method for installing and removing tire chains is also described in which the base is positioned in adjacent to the inside tire on a dual tire, single axle. The motor vehicle is then driven onto the tire support surface which elevates both tires and chains can be installed on the outside tire.

Notice is given that the following patent document contains original material subject to copyright protection. The copyright owner has no objection to the facsimile or digital download reproduction of all or part of the patent document but otherwise reserves all copyrights.

This utility patent application is based on and claims the filing date benefit of U.S. provisional patent application (Application No. 61/820323) filed on May 7, 2013.

### BACKGROUND OF THE INVENTION

1. Field of the Invention

This invention pertains to an apparatus and method for installing a tire chain on a tire, and more particularly, to apparatuses and methods for installing a tire chain on the outside tire on the two outer tires on dual tires mounted on opposite sides of the single axle.

2. Description of the Related Art

Most states in the U.S. have promulgated laws and regulations that require using approved traction devices on motor vehicles operated on public roads in snowy or icy conditions. The type of traction device and the specific location of the tire where the traction device must be installed are also set forth in the laws and regulations. Normally, the type of traction device and the tire location is determined by the type of motor vehicle (i.e. passenger, vehicle, light truck vehicle, heavy truck vehicle, tractor/trailer vehicle, etc) and the motor vehicle's axle arrangement (two to four axles, five axles, and six or more axles). For example, on light or heavy trucks with dual tires on opposite sides of a single axle, metal chains must be used and installed on the two outside tires. On tractor/trailer vehicles with one or more single axles with dual tires on opposite sides on both the tractor and on the trailer, metal chains must be used and installed on the two outside tires on a single axle on the tractor and on at least one outside tire on a single dual tire arrangement on the trailer.

Drivers of heavy trucks and tractor/trailer vehicles often drive alone. When weather conditions require installation of tire chains, the driver must personally install the tire chains on the tires. Normally, the driver must find a safe flat area to park the truck or tractor/trailer vehicle. The driver then must exit the cab and spread each chain longitudinally on the ground in front of the desired tires. The driver then returns to the cab and slowly drives the truck or tractor/trailer forward so the center axis of each tire is aligned over the central transverse axis of the chain. Unfortunately, determining the location of the tires to determine if they are properly aligned over the chains is difficult using the vehicle's outside rear view mirrors. As a result, the driver must sometimes repeatedly exit and reenter the cab to properly align the tires over the chains.

What is needed is an apparatus and an improved method that allows a single driver to easily and safely install and remove tire chains from an outside tire on a motor vehicle with dual tires on a single axle.

### SUMMARY OF THE INVENTION

Disclosed is an apparatus and method for easily and safely installing or removing tire chains from the outside tire on a dual tire, single axle on a large motor vehicle. The apparatus includes a pyramid, or triangular -shaped base with a flat bottom surface, two vertical side walls, two upward converging top surfaces, and an elevated, centrally located, concave tire support surface disposed between the two converging surfaces. The apparatus also includes a tire sensor gauge mounted in the tire support surface, and a signaling device coupled to the tire sensor that informs the driver when a desired tire has been successfully driven onto and properly aligned on the tire support surface.

During use, the base is positioned on a flat surface and longitudinally aligned with the rolling track of one of the inside tires on dual tire arranged on opposite sides of a single axle. The lower edge of the converging surface is transversely aligned and positioned against the tire's tread. The motor vehicle is then driven in a direction towards the base so the tire rolls over the converging surface and onto the tire support surface. The arc or curvature of the tire support surface is slightly greater than the outer curvature of the section of the tire in contact with the apparatus partially capturing the tire and prevent rolling. The angles of the two converging surfaces and the curvature of the tire support surface are sufficient so the tangent point of the tire when aligned with the center axis of the tire support surface is elevated approximately 3 inches above the ground.

The tire sensor is mounted over the center axis of the tire support surface. In one embodiment shown, the tire sensor is a pressure gauge that registers a downward force exerted by the tire when it rolls over the center axis of the tire support surface. When the pressure gauge is forced downward, the operational stage of a signaling device is changed informing the driver located in the cab of the truck or tractor/trailer vehicle that the tire is properly aligned. In one embodiment, the signaling device is a light source attached to a cable connected to the tire sensor. In one embodiment, the light source is configured to be activated when the tire rolls onto the tire support surface. When the gauge is extended upward, the light source is deactivated. The cable has a sufficient length so that during use, the cable and the light source may be positioned on the flat surface outside the outside tire to allow a driver to view the activation state of the light source in the truck cab using the rear view mirrors.

When the inside tire is elevated off the flat surface, the outside tire adjacent to the elevated tire is also elevated. A tire chain can then be easily installed on the outside tire.

In one embodiment, the base is made of lightweight plastic and sold and distributed in a pair so the driver may simultaneously install chains on the two outside tires. Elastic straps are provided that enable two apparatus to be held with their flat surfaces pressed together.

### DESCRIPTION OF THE DRAWINGS

FIG. 1 is a perspective view of a single axle with a dual tire arrangement used on a motor vehicle with two apparatus positioned on the ground in the rolling track path of the two inside tires.

FIG. 2 is a perspective view of the apparatus.

FIG. 3 is a top plan view of the apparatus.

FIG. 4 is a bottom plan view of the apparatus.

FIG. 5 is a sectional side elevation view of the apparatus.

FIG. 6 is an end elevation view of the apparatus.

FIG. 7 is a perspective view showing two apparatuses stacked together for compact storage.

FIG. 8 is an exploded perspective view of the two apparatuses shown in FIG. 7.

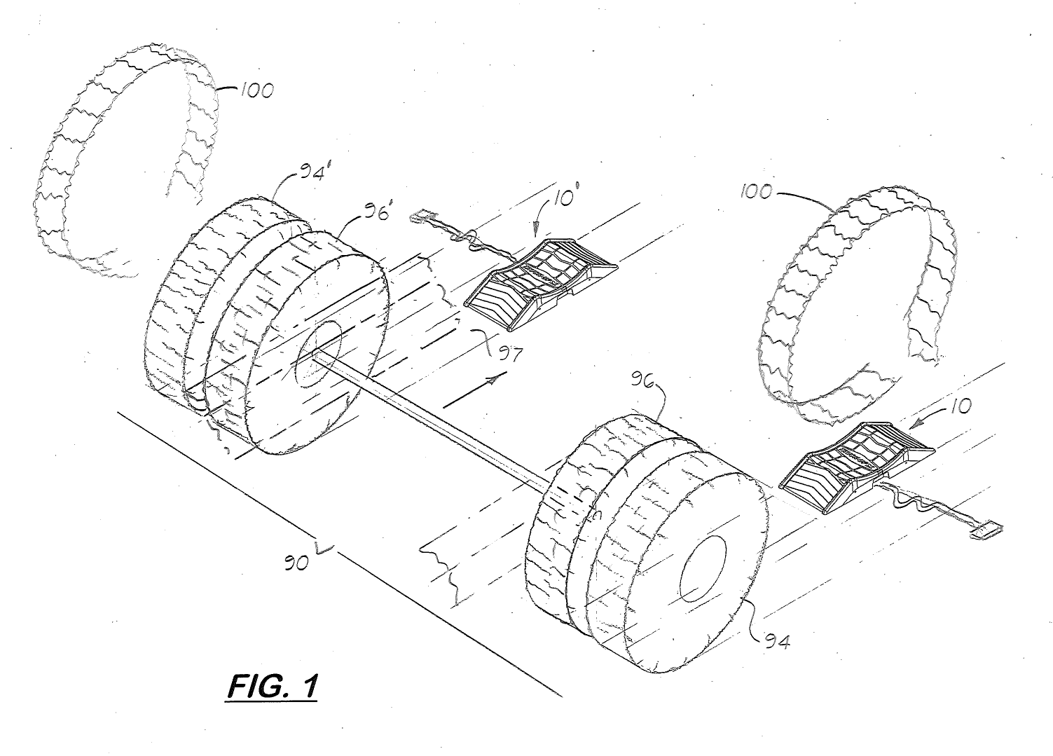

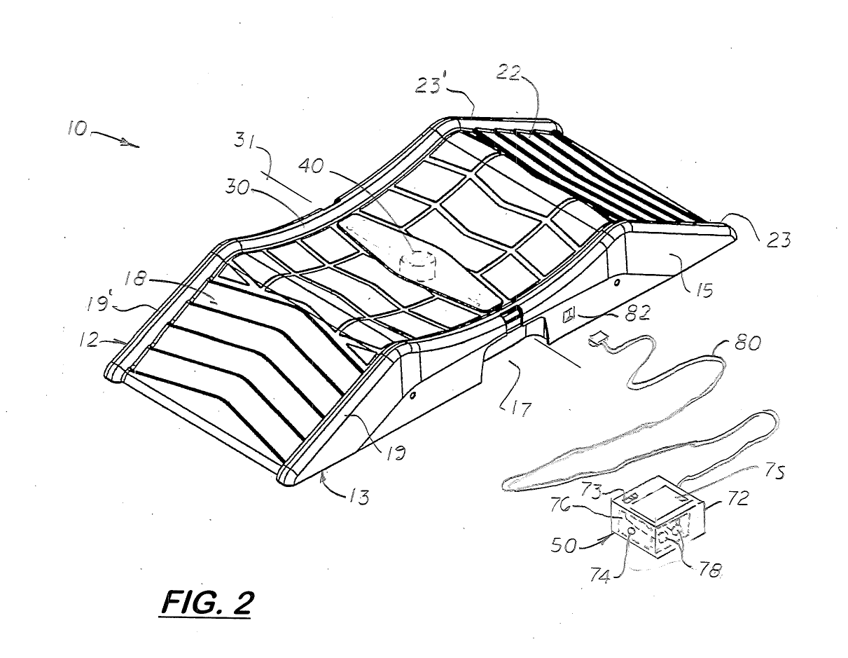

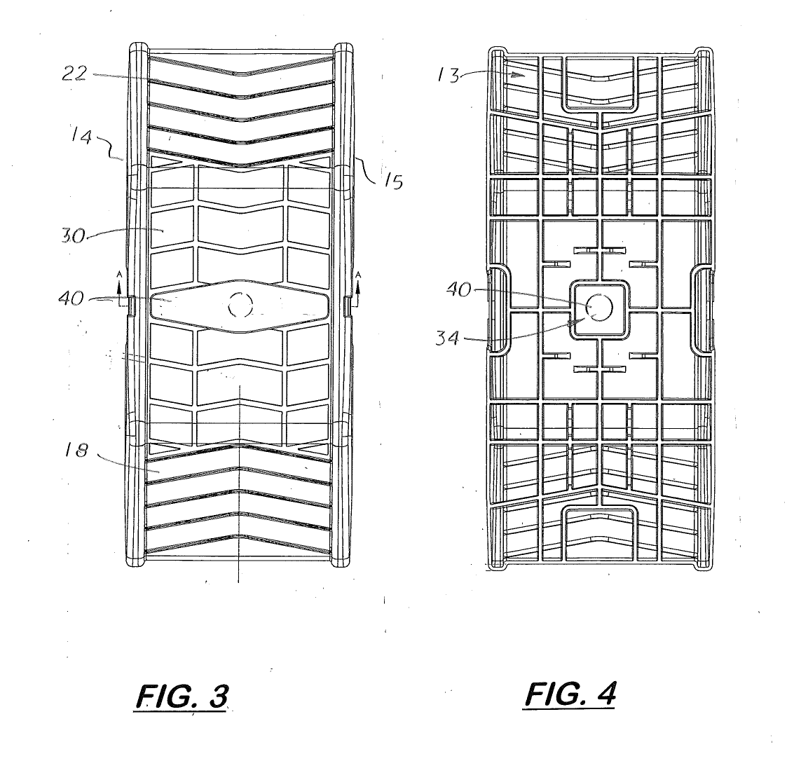

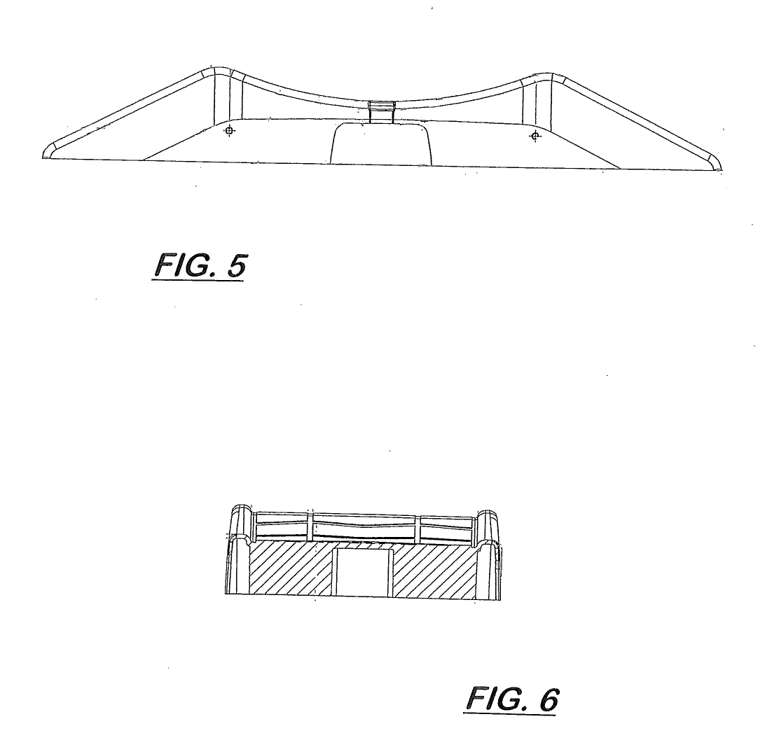

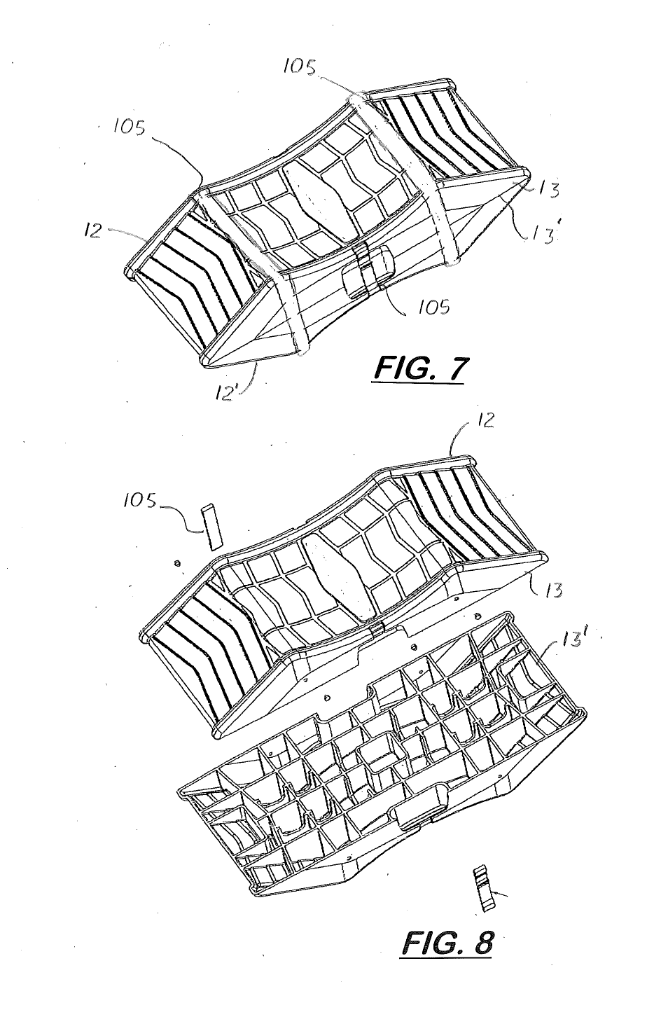

### DESCRIPTION OF THE PREFERRED EMBODIMENT(S)

Referring to the Figs, there is disclosed an apparatus 10 for easily and safely installing or removing a tire chain 100 from the outside tire 94 on a dual tire , single axle arrangement 90 on a motor vehicle 92. The apparatus 10 includes a four sided pyramid base 12 with a triangular side profile with a bottom surface 13, two vertical side walls 14, 15, two upward converging surfaces 18, 22, an elevated , centrally located concave tire surface 30 disposed between the two converging surfaces 18, 22. Formed on the outer edges of the two converging surfaces 18, 22 are raised curbs 19, 19′ and 23, 23′. In the tire support surface 30 is a tire centering sensor 40. Coupled to the tire centering sensor 40 is a signaling device 50 that informs the driver when an inside tire 96 on a dual tire arrangement on a single axle 90 has been driven onto and properly aligned on the tire support surface 30.

In the embodiment, the base 12 is made of molded, lightweight plastic and measures approximately 31 inches in length and approximately 13.5 inches in width. The converging surfaces 18, 22 are angled upward at approximately 27 degrees from the flat bottom surface 13. The tire support surface 30 has a radius of approximately 21 inches. The lower center tangent point 31 of the tire support surface 30 is approximately 3 inches above the bottom surface 13. Formed on the tire support surface 30 is a centrally located valve cavity 34 configured to receive a tire sensing valve 40. Also formed on the side wall 16 is an optional storage cavity 17 for signaling device 50. The arc or curvature of the tire support surface 30 is slightly greater than the outer curvature of the section of the tire 96 in contact with the base 12 thereby capturing the tire 96 within the tire support surface 30.

In one embodiment, the signaling device 50 is a rectangular box 72 with at least one light bulb or LED mounted 74 hereon. Mounted inside the box 72 is a manual switch 73 and a battery compartment 76 that houses one or more batteries 78 that operate the light bulb or LED 74. The signaling device 50 also includes a cable 80 that connects at its opposite end to a plug port 82 on the side wall 15 of the base 12. The plug port 82 is electrically connected to the sensing valve 40 so that when the operational condition (ON or OFF) of the signaling device 50 changes when a tire 96 rolls over and forces the sensing valve 40 downward.

During use, the base 12 is positioned on a flat surface and longitudinally aligned with the rolling track 97 of the inside tire 96 on a dual tire single axle arrangement 90. The adjoining edge between the bottom surface 13 one of the converging surface 18 or 22 is positioned transversely against tire's tread. The box 72 and the cable 80 are positioned lateral to the apparatus 10 so it may be seen by the driver sitting in the cab and operating the motor vehicle. The motor vehicle is then driven in a direction towards the apparatus 10 so the inside tire 96 rolls over the adjacent converging surface 18 or 22 and into the tire support surface 30.

When the inside tire 96 rolls onto the tire support surface 30 and activates the sensor valve 40, the operating state of the light bulb or LED 74 on the box 72 changes. During use, the cable 80 is extended along the ground and the box 72 are positioned so the driver may view the operating condition of the bulb or LED 82 with the rear view mirrors. As the driver drives the tractor onto the tire support surface 30, he or she watches the operating condition of the LED 74. When the operative condition changes, the brakes are applied and set and the driver can then install chains 100 to the elevated outside tire 94 adjacent to the elevated inside tire 96. Because the outside tire 94 is also elevated off the ground, the chain 100 may be easily installed on the outside tire 94. When the chain 100 has been installed, the motor vehicle is then driven forward and away from the base 12. The apparatus 10 can then be used raised other inside tires 96 to install chains 100 on other outside tires 94 or returned to its storage space.

In one embodiment, base 12 is made of lightweight plastic and sold and distributed in pairs (12, 12′) as shown in FIGS. 8 and 9, so the driver may simultaneously install chains 100 on the two outside tires 94, 94′. The bases 12, 12′ are nested together and elastic straps 105 are provided that hold their flat bottom surfaces 13, 13′ longitudinally aligned and pressed together.

Using the above described apparatus 10, a method for installing and removing tire chains is also described in which the base is positioned in adjacent to the inside tire on a dual tire, single axle arrangement 90. The driver first determines the inside tire 96 adjacent the outside tire 94 where a tire chain 100 will be installed. The driver then selects a base 12 and positions it longitudinally over the tire track 97. The light senor 72 is connected to the base 12 and then positioned on the ground laterally from the outside tire 94 so the LED 74 may be seen by the driver via the outside rear view mirrors. The driver then slowly drives the motor vehicle forward or rearward until the condition of the LED 74 changes indicating that the inside tire 96 is properly positioned over the tire support area 30. The driver then installs the tire chain 100 around the elevated outside tire 94. The driver then drives the truck forward or reward so the base 12 is free and may be retrieved. The above process is then repeated in reverse to remove the tire chain from the other outside tire 94.

In compliance with the statute, the invention described has been described in language more or less specific as to structural features. It should be understood however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

I claim:

1. An apparatus for installing or removing tire chains from the outside tire on a dual tire, comprising:
a. a base with two upward converging surfaces, an elevated concave tire support surface disposed between the two converging surfaces;
b. a tire sensor valve mounted centrally in the tire support surface; and,
c. a signaling device coupled to said tire sensor valve configured to generate a visual signal when a tire has been driven onto the apparatus and aligned over said sensor valve.

2. The apparatus as recited in claim 1, wherein said signaling device is a box with at least one light mounted thereon, said box being electrically connected to said sensor valve.

3. The apparatus as recited in claim 1, wherein said light is an LED.

4. The apparatus as recited in claim 1, further including a storage cavity formed on said base configured to said box.

5. The method for installing and removing tire chains comprising the following steps:
a. selecting a base with two upward converging surfaces, an elevated concave tire support surface disposed between the two converging surfaces, a tire sensor valve mounted centrally in the tire support surface, and a signaling device coupled to said tire sensor valve configured to generate a visual signal when a tire has been driven onto the apparatus and aligned over said sensor valve.
b. positioning said base adjacent to the inside tire on a dual tire, single axle arrangement, said light senor being positioned on the ground adjacent to the tire so the light may be seen by the driver via the outside rear view mirrors;
c. driving slowly drives the motor vehicle forward or rearward until the condition of the light changes indicating that the inside tire is properly positioned over the tire support area;
d. installing tire chain on the outside tire adjacent to the tire located over the base; and
e. driving motor vehicle forward or reward so the base is free and may be retrieved. The above process is then repeated in reverse to remove the tire chain from the other outside tire.
